(19) United States
(12) Patent Application Publication
(10) Pub. No.: US 2007/0021848 A1
(43) Pub. Date: Jan. 25, 2007

(54) Testing system and related method for testing an electronic device by determining a power on/off signal

(75) Inventor: Chih-Wei Huang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/363,674

(22) Filed: Feb. 27, 2006

(30) Foreign Application Priority Data
Jul. 21, 2005 (TW) 094124643

(51) Int. Cl. G05B 11/01

(52) U.S. Cl. 700/22

(57) ABSTRACT

A testing method and related system enables a power management device to power-on or power-off a second electrical device via a first transmission interface of a first electrical device. The first electrical device sets power-on and power off times of the power management device. The first electrical device sends a power-on or a power-off control instruction to the power management device via the first transmission interface based on the set power-on and power-off times to power-on or power-off the power management device, and the first electrical device performs a timing process. The second electrical device executes a corresponding power-on or power-off process based on power statuses of the power management device. The first electrical device determines whether the second electrical device returns with a power-on or a power-off testing signal as a testing result within a predetermined time during the process of timing.

### BACKGROUND OF THE INVENTION

1. Field of the Invention

The present invention relates to power-on/power-off testing technologies, and more particularly, to a testing system and related method for enabling a first electrical device to control power of a power management device to a second electrical device in order to perform power-on/power-off test on the second electrical device.

2. Description of Related Art

Along with the continuing development of electronic technology and network communication technology, electrical equipment with powerful function has emerged in the market, facilitating the daily live of people. During research and development of electrical equipment, usually the products have to be continuously tested to ensure their qualities. These tests for example are temperature test, stability test, impact test or power-on/-off test.

In terms of power-on/power-off test, a conventional testing system is used in conjunction with a plurality of power management devices to perform power-on/power-off test on electrical equipment to be tested. However, this testing system has the following disadvantages: (1) the size of equipment used for the testing system is usually very large, which means the testing equipment cannot be easily adapted to environment for testing, and once the equipment is fixed, moving the equipment is also not convenient; (2) if one of the power management. devices is malfunctioned, then the whole set of system cannot operate properly, and diagnosis of the malfunction is also not very convenient, additionally, using a plurality of power management device for power-on/power-off testing somewhat increases testing cost; (3) conventional testing host employing DOS environment has impeded future management and function development; (4) most conventional power-on/power-off testing systems require manual operations to switch-on/switch-off power repeatedly and perform timing on the power-on/power-off times, which consumes a lot of manpower and the testing procedures are complex. For example, if we need to test whether electrical equipment can successfully power on when power is provided thereto and whether malfunction occurs, we need to manually and repeatedly turn on and off the power switch of the electrical equipment several hundred times or even million times, which is indeed time- and resource-consuming. Conventional power-on/-off testing technology cannot meet the timely demands of products in current industry.

In view of this, there is need for a power-on/-off testing system and method with a simple structure and small size that simplifies manual testing procedures, thereby solving the problems in the prior art as mentioned before.

### SUMMARY OF THE INVENTION

In the light of forgoing drawbacks, a primary objective of the present invention is to provide a testing system and related method to achieve a simple-structured and small-sized power-on/power-off equipment.

Another objective of the present invention is to provide a testing method and related system that does not require testing personnel to input power-on/power-off commands repeatedly to an electrical equipment being tested, thereby fast and convenient power-on/power-off testing can be realized.

In accordance with the above and other objectives, the present invention provides a testing system and related method, which enables a power management device to power-on or power-off a second electrical device via a first transmission interface of a first electrical device. The testing system includes a setting module for setting power-on and power-off times; a first control unit for sending a control instruction to the power management device based on the power-on and power-off times set by the setting module to power-on or power-off the power management device, and starting to counting a test time as soon as the performing a timing process based on power statuses of the power management device; a processing module for executing a corresponding power-on or power-off process based on the power status of the power management device, and wherein the second electrical device returns a power-on or a power-off testing signal via a second transmission interface when executing the power-on or power-off process; and a second control unit for determining whether the processing module returns the power-on or a power-off testing signal as a testing result within a predetermined time during the timing process performed by the first control unit.

The testing method includes setting power-on and power off times of the power management device with the first electrical device; sending a power-on or a power-off control instruction with the first electrical device to the power management device via the first transmission interface based on the set power-on and power-off times to enable the power management device to turn on or off a power switch, and performing a timing process with the first electrical device based on power statuses of the power management device; executing a corresponding power-on or power-off process with the second electrical device based on the power statuses the power management device via the first transmission interface, wherein the second electrical device returns a power-on or a power-off testing signal via the second transmission interface; and determining with the first electrical device whether the second electrical device returns a power-on or a power-off testing signal as a testing result within a predetermined time during the timing process.

### BRIEF DESCRIPTION OF DRAWINGS

The present invention can be more fully understood by reading the following detailed description of the preferred embodiments, with reference made to the accompanying drawings, wherein:

FIG. 1 is a block diagram showing a testing system of the present invention; and

FIG. 2 is a flowchart showing a testing method of the present invention.

### DETAILED DESCRIPTION OF PREFERRED EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

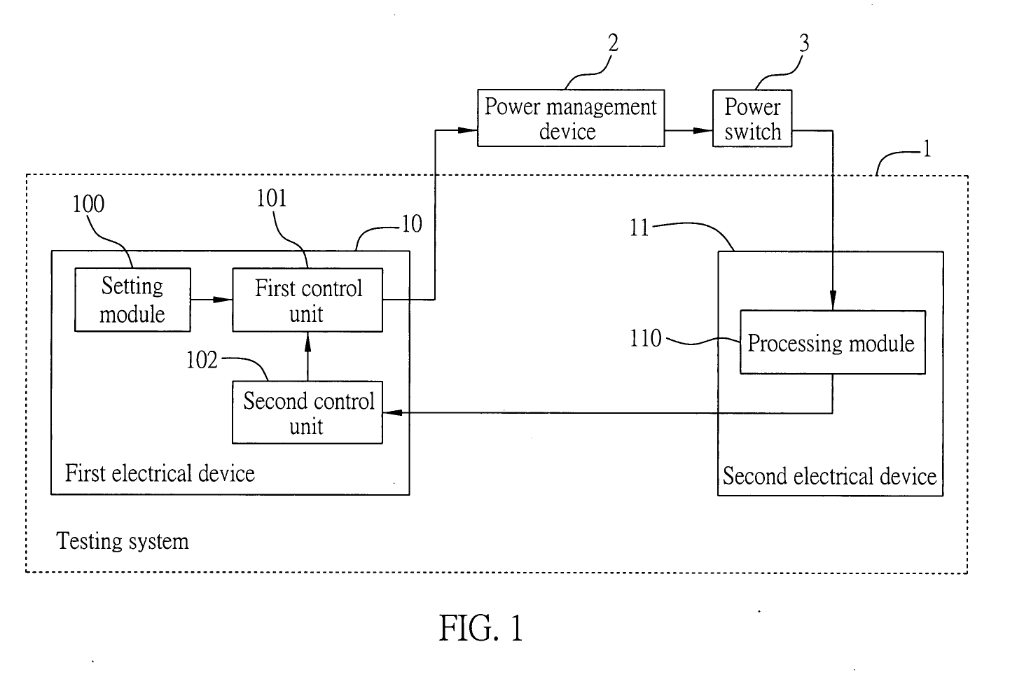

FIG. 1 shows a schematic diagram of a testing system 1 of the present invention. The testing system 1 controls a power management device 2 via a first electrical device 10 to turn on a power switch 3 so as to perform a power on/off testing on a second electrical device 11. Thereafter, the second electrical device 11 replies with a testing signal to the first electrical device 10, so that the first electrical device 10 determines the power on/off condition of the second electrical device 11 according to the testing signal replied by the second electrical device 11. The testing system 1 comprises a setting module 100, a first control unit 101, a processing module 110 and a second control unit 102. As can be seen from FIG. 1, the setting module 100, the first control unit 101 and the second control unit 102 are all installed in the first electrical device 10, such as a controlling host. The processing module 110 is installed in the second electrical device 11, such as a testing product. It should be noted that the first electrical device 10 and the second electrical device 11 applied to the testing system 1 of the present invention have other functional units, such as a display unit or an input unit etc. Only those components related to the present invention are illustrated in order to simplify the drawings and the description.

The setting module 100 allows a user to set a power-on time and a power-off time for the second electrical device 11 via the first electrical device 10. Typically, the setting module 100 is a program written in specific programming language, for example, Visual Basic or C language. The user performs the settings of power on/off timing via an input unit (not shown) electrically connected with the first electrical device 10, such as a keyboard, a keypad, or a mouse etc.

According to the setting module 100, the first control unit 101 sends power on/off control instructions to the power management device 2 in order to turn on or turn off the power switch 3, and performs a timing process when the power is on/off. The first control unit 101 uses a first transmission interface (not shown here) to allow the first electrical device 10 to electrically connect to the power management device 2, so as to control the power management device 2 to perform the power on/off testing on the second electrical device 11 via the first transmission interface. In one preferred embodiment, the first transmission interface is a connection port provided on the first electrical device 10, such as a parallel transmission port or a serial transmission interface (e.g. RS232 port), and the power management device 2 is an Alternating Current Solid State Relay (AC SSR) or a direct current relay. Since the operating principles of the above-described parallel transmission port, serial port, AC SSR, and direct current relay are well known to those skilled in the art, their operating functions and infrastructures will not be described in details below. The first control unit 101 can be programmed by a specific programming language, such as VB or C language.

Upon the power management device 2 turning on/off the power switch 3, the processing module 110 correspondingly executes power on/off tasks and records the conditions and number of times thereof. The processing module 110 uses a second transmission interface (not shown) to allow the second electrical device to electrically connect to the first electrical device 10, so that the second electrical device 11 is able to reply with power on/off testing signals to the first electrical device 10 via the second transmission interface in order for the first electrical device 10 to determine whether the second electrical device 11 can be powered on/off properly. The processing module 110 can be programmed by a specific programming language, such as VB or C language. In this embodiment, the processing module 110 performs two steps, one is to record and accumulate the number of times the second electrical device 11 is powered on/off, and the other is to reply a power on/off testing signal to the first electrical device 10 via the second transmission interface. For this embodiment, the second transmission interface can be a connection port (serial transmission port or parallel transmission port) provided on the first electrical device 10 and the second electrical device 11.

During the timing process performed by the first control unit 101 of the first electrical device 10, the second control unit 102 determines whether the processing module 110 of the second electrical device 11 replies with a power on/off testing signal within a predetermined period of time. If so, then the number of success is accumulated, else the number of failure is accumulated. The second control unit 102 can be programmed by a specific programming language (e.g. C or VB).

From the above, it can be understood that by using the testing system 1 of the present invention, testing personnel can easily and quickly perform power on/off testing on the second electrical device 11 through the first electrical device 10. Additionally, the testing personnel do not have to repeatedly input power on/off control commands to the first electrical device 10. The first electrical device 10 is able to automatically adjust the required number of power on/off testing based on the testing accuracy required.

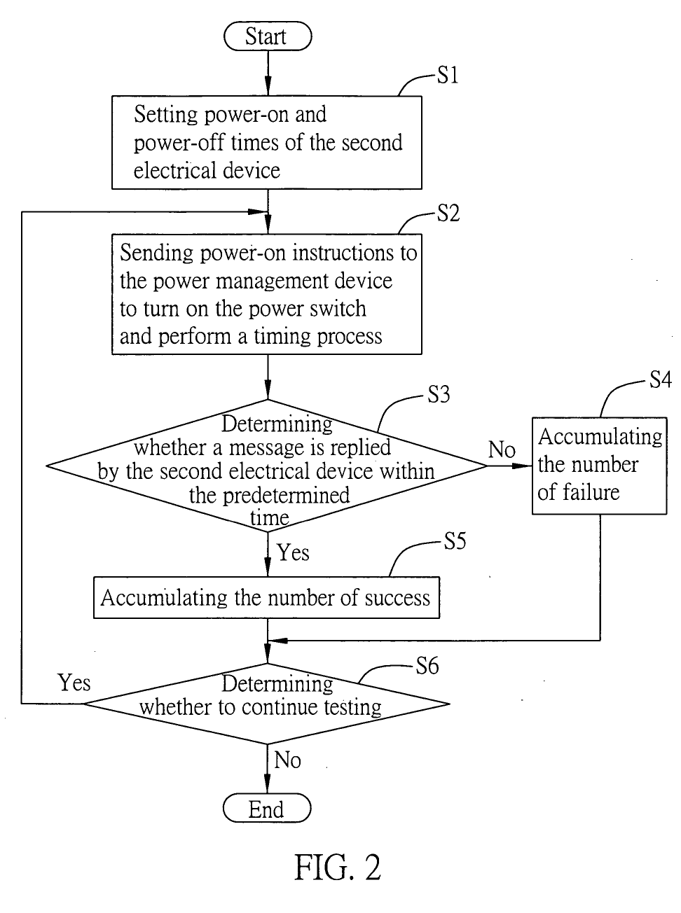

FIG. 2 is a flowchart showing a testing method of the present invention. As seen, this embodiment is used to primarily illustrate the operating procedures of the first electrical device 10. First step S1 is executed. Testing personnel set the time for power on/off of the power management device 2 via the setting module 100 of the first electrical device 10, which in turn determines the power on/off time of the second electrical device 11. The power on/off timing can be set by the testing personnel based on actual testing requirement. The following steps only illustrate the powering on procedures. Then, step S2 is performed.

In step S2, based on the power-on time set by the setting module 100, the first control unit 101 of the first electrical device 10 sends a power-on instruction to the power management device 2 via the first transmission interface in order to turn on the power switch 3, and performs a timing process when the power is turned on. Then, step S3 is performed.

In step S3, during the timing of the first electrical device 10, the second control unit 102 determines whether a power-on testing signal is replied by the second electrical device via the second transmission interface within a predetermined period of time. If so, step S5 is executed, else step S4 is executed.

In step S4, the second control unit 102 of the first electrical device 10 does not receive the power-on testing signal from the second electrical device 11 via the second transmission interface within the predetermined period of time, thus a failure result is recorded, and the number of failure is accumulated if required. Then, step S6 is performed.

In step S5, the second control unit 102 of the first electrical device 10 receives the power-on testing signal from the second electrical device 11 via the second transmission interface within the predetermined period of time, thus a success result is recorded, and the number of success is accumulated if required. Then, step S6 is performed.

In step S6, the first electrical device 10 determines whether to continue the testing according to the power-on/-off time set by the setting module 100. If yes, step S2 is performed; else the power on/off testing task is completed.

It should be noted that after step S2 is performed, under normal circumstances when the second electrical 11 is properly powered on upon receiving the power provided via the power switch 3, the processing module 110 of the second electrical device 11 records the power-on/-off testing result, and accumulates the number of success/failure if required. Thereafter, a testing signal can be returned to the first electrical device 10 via the second transmission interface to inform a successful power-on.

In summary, the testing system and method of the present invention eliminates the problems in the prior art, that is, the large size of equipment and large number of components therein and the complicated testing procedures involved in the conventional power-on/-off testing. Furthermore, the number of times the power-on/power-off instructions issued by the first electrical device can be recorded and the power-on/power-off time can also be set by a user. The power-on/-off results for the second electrical device being tested can be recorded, so that the number of power-on/off testing can be traced and adjusted automatically based on the required testing accuracy. Additionally, the testing results between the controlling end and the testing end can be compared based on the recorded contents. Therefore, the testing system and method of the present invention possess non-obvious advantages over the traditional power-on/-off testing method.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A testing system for enabling a power management device to power-on or power-off a second electrical device via a first transmission interface of a first electrical device, the testing system comprising:
a setting module for setting power-on and power-off times;
a first control unit for sending a control instruction to the power management device based on the power-on and power-off times set by the setting module to power-on or power-off the power management device, and starting to counting a test time as soon as the performing a timing process based on power statuses of the power management device;
a processing module for executing a corresponding power-on or power-off process based on the power status of the power management device, and wherein the second electrical device returns a power-on or a power-off testing signal via a second transmission interface when executing the power-on or power-off process; and
a second control unit for determining whether the processing module returns the power-on or a power-off testing signal as a testing result within a predetermined time during the timing process performed by the first control unit.

2. The testing system of claim 1, wherein the processing module further records power statuses of the second electrical device during the execution of powering-on and powering-off of the second electrical device based on the power statuses of the power management device, and the second control unit further records the testing signal when determining whether the processing module returns the power-on the power-off signal within the predetermined time, so as to allow testing personnel to compare the operating results of the first electrical device and the second electrical device based on the recorded contents.

3. The testing system of claim 1, wherein the first transmission interface is one selected from the group consisting of a print transmission port and a serial transmission port.

4. The testing system of claim 1, wherein the second transmission interface is one selected from the group consisting of a parallel transmission port and a serial transmission port.

5. The testing system of claim 1, wherein the power management device is one selected from the group consisting of an Alternating Current Solid State Relay (AC SSR) and a direct current relay.

6. The testing system of claim 1, wherein the setting module, the first control unit and the second control unit are all installed in the first electrical device.

7. The testing system of claim 1, wherein the processing module is installed in the second electrical device.

8. The testing system of claim 1, wherein the setting module, the first control unit, the second control unit and the processing module are written in a specific programming language.

9. A testing method for enabling a power management device to power-on or power-off a second electrical device via a first transmission interface of a first electrical device, the second electrical device returning signals to the first electrical device via a second transmission interface, the testing method comprising:
setting power-on and power off times of the power management device with the first electrical device,
sending a power-on or a power-off control instruction with the first electrical device to the power management device via the first transmission interface based on the set power-on and power-off times to enable the power management device to turn on or off a power switch, and performing a timing process with the first electrical device based on power statuses of the power management device;
executing a corresponding power-on or power-off process with the second electrical device based on the power statuses the power management device via the first transmission interface, wherein the second electrical device returns a power-on or a power-off testing signal via the second transmission interface; and
determining with the first electrical device whether the second electrical device returns a power-on or a power-off testing signal as a testing result within a predetermined time during the timing process.

10. The testing method of claim 9, wherein the second electrical device further records power statuses of the second electrical device during the execution of powering-on and powering-off of the second electrical device based on the power statues of the power management device, and the first electrical device further records the testing signal when determining whether the second electrical device returns the power-on or the power-off signal within the predetermined time, so as to allow testing personnel to compare the operating results of the first electrical device and the second electrical device based on the recorded contents.

11. The testing method of claim 9, wherein the first transmission interface is one selected from the group consisting of a parallel transmission port and a serial transmission port.

12. The testing method of claim 9, wherein the second transmission interface is one selected from the group consisting of a parallel transmission port and a serial transmission port.

13. The testing method of claim 9, wherein the power management device is one selected from the group consisting of an AC SSR and a direct current relay.
